(19) United States
(12) Patent Application Publication
(10) Pub. No.: US 2023/0034982 A1
(43) Pub. Date: Feb. 2, 2023

(54) AQUEOUS BINDER FOR INORGANIC FIBER HEAT-INSULATING AND SOUND-ABSORBING MATERIAL AND INORGANIC FIBER HEAT-INSULATING AND SOUND-ABSORBING MATERIAL

(71) Applicant: ASAHI FIBER GLASS CO., LTD., Chiyoda-ku, Tokyo (JP)

(72) Inventor: NAMI FUNAKOSHI, Toky (JP)

(73) Assignee: ASAHI FIBER GLASS CO., LTD., Chiyoda-ku, Tokyo (JP)

(21) Appl. No.: 17/798,291

(22) PCT Filed: Feb. 17, 2021
(86) PCT No.: PCT/JP2021/005965

§ 371 Date: Aug. 8, 2022

(30) Foreign Application Priority Data
Feb. 28, 2020 (JP) 2020-034104

(51) Int. Cl. C08J 5/24; C08F 120/06; C08K 5/17; C08K 5/544; C08K 5/405

(52) U.S. Cl. CPC C08J 5/249; C08F 120/06; C08K 5/17; C08K 5/405; C08K 5/544; C08F 2810/20; C08J 2333/02; E04B 1/88

(57) ABSTRACT

The present invention relates to an aqueous binder for a heat-insulating and sound-absorbing inorganic fiber material, the aqueous binder comprising a polymer having a carboxy group and a crosslinking agent for the polymer, wherein the crosslinking agent comprises an alkanol monoamine and a polyamine having an imino group, the polyamine has an amine value of 1200 to 1650 mg KOH/g, and a ratio of the total number of moles of amino groups and imino groups in the crosslinking agent with respect to the total number of moles of hydroxyl groups, amino groups, and imino groups in the crosslinking agent is 0.6 or less.

### TECHNICAL FIELD

The present invention relates to an aqueous binder for a heat-insulating and sound-absorbing inorganic fiber material, and a heat-insulating and sound-absorbing inorganic fiber material.

### BACKGROUND ART

Generally, inorganic fiber heat-insulating sound-absorbers such as glass wool and rock wool are manufactured by attaching a binder to inorganic fibers and then curing the binder. Regarding the binder, aqueous binders containing a polymer having a carboxy group or the like, a crosslinking agent having an amino group or the like, and water, are known (for example, Patent Literature 1).

### Citation List

### Patent Literature

Patent Literature 1: Japanese Unexamined Patent Publication No. 2013-117083

### SUMMARY OF INVENTION

### Technical Problem

With regard to an aqueous binder such as described above, since the aqueous binder contains a polymer having a carboxy group or the like, the pH is lowered, and water dilution capacity is decreased due to the lowered pH, so that there is a risk that precipitates may be generated at the time of manufacturing an inorganic fiber heat-insulating sound-absorber. Thus, in order to prevent such lowering of the water dilution capacity and exhibition of precipitates, neutralization by means of ammonia is often carried out in the manufacturing process for the aqueous binder. However, when ammonia is incorporated, volatilization of ammonia occurs at the time of use, and therefore, there is concern for environmental safety.

An object of the present invention is to provide an aqueous binder for a heat-insulating and sound-absorbing inorganic fiber material, the aqueous binder having sufficient water dilution capacity even without containing ammonia, having a sufficiently rapid curing rate, and having excellent environmental safety, and to provide a heat-insulating and sound-absorbing inorganic fiber material obtained by using the aqueous binder.

### Solution to Problem

The present invention provides an aqueous binder for a heat-insulating and sound-absorbing inorganic fiber material, the aqueous binder comprising a polymer having a carboxy group and a crosslinking agent for this polymer, wherein the crosslinking agent comprises an alkanol monoamine and a polyamine having an imino group.

The aqueous binder of the present invention is a product obtained by combining a polymer having a carboxy group with the above-mentioned crosslinking agent, and the aqueous binder can prevent a decrease in pH even without incorporating ammonia and thereby can have sufficient water dilution capacity. In addition, since the aqueous binder can be diluted in the absence of ammonia, the aqueous binder does not interrupt the reaction between a carboxy group in the polymer and an amino group or the like of the crosslinking agent, and the curing time of the binder can be shortened. Moreover, since ammonia gas as a volatile component is not generated from the aqueous binder, the aqueous binder has excellent environmental safety. Furthermore, since it is not necessary to incorporate ammonia, there is no problem of pH change in the aqueous binder concomitant to the volatilization of ammonia. The aqueous binder of the present invention having such characteristics can also be expressed as a non-ammonia-containing aqueous binder for a heat-insulating and sound-absorbing inorganic fiber material. However, on the occasion of use, the addition of ammonia afterwards is not entirely prohibited.

It is preferable that the above-described polymer is a polymer having an ethylenically unsaturated monomer having a carboxy group as a monomer unit. By using a polymer obtained by polymerizing an ethylenically unsaturated monomer having a carboxy group, the quantity of carboxy groups per one molecule can be increased, and as a result of combining with a suitable chain transfer agent, the control of the weight average molecular weight is also facilitated. Therefore, the functions as an aqueous binder can be enhanced by using such a polymer, and at the same time, the variations in various physical properties of inorganic fiber heat-insulating sound-absorbers can also be reduced.

It is preferable that a ratio of the total number of moles of hydroxyl groups, amino groups, and imino groups in the crosslinking agent with respect to the total number of moles of carboxy groups in the polymer having a carboxy group (hereinafter, referred to as “mole ratio 1”) is 0.5 or greater. By adjusting the mole ratio 1 to 0.5 or greater, the reaction between the polymer having a carboxy group and the crosslinking agent component can be performed sufficiently rapidly, and since a sufficient amount of a crosslinked structure is formed, the various physical properties of the obtained heat-insulating and sound-absorbing inorganic fiber material can be optimized.

It is preferable that a ratio of the total number of moles of amino groups and imino groups in the crosslinking agent with respect to the total number of moles of hydroxyl groups, amino groups, and imino groups in the crosslinking agent (hereinafter, referred to as “mole ratio 2”) is 0.6 or less. The mole ratio 2 is the ratio of functional group species in the crosslinking agent as a whole; however, surprisingly, it was found that this ratio serves as a factor that greatly contributes to the performance of the aqueous binder, such as water dilution capacity, curing rate, and environmental safety.

The hydroxyl group of the crosslinking agent forms an ester with a carboxy group of the polymer; however, since condensation proceeds concomitantly with dehydration, the reaction rate is slow, and it is generally said that it is necessary to increase the degree of curing of the binder by raising the temperature at the time of curing the binder or by lengthening the heating time. Therefore, when the crosslinking agent has both a hydroxyl group and an amino group (or an imino group), in order to increase the curing rate, it is usually presumed to decrease the quantity of hydroxyl groups and increase the quantity of amino groups (or imino groups). However, contrary to such understanding, there was obtained a novel finding that when the ratio of the total number of moles of amino groups and imino groups is set to the low range side such as 0.6 or less, the water dilution capacity and storage stability as well as the curing rate are further enhanced.

It is preferable that the polyamine having an imino group has a molecular weight of 100 to 500 and an amine value of 1150 to 1650 mg KOH/g. When the molecular weight is adjusted to the above-described range, the molecular length between crosslinking points can be adjusted to easily exhibit the characteristics required for the use applications of the aqueous binder (manufacturing of a heat-insulating and sound-absorbing inorganic fiber material, and the like). Furthermore, by adjusting the amine value to the above-described range, the reactivity can be increased, and shortening of the curing time of the binder is facilitated.

It is preferable that the polymer having a carboxy group has a weight average molecular weight of 1000 to 20000 and an acid value of 500 to 900 mg KOH/g. By adjusting the weight average molecular weight to the above-described range, the physical properties such as the elastic modulus of a cured product after a crosslinking reaction can be made suitable. Furthermore, by adjusting the acid value to the above-described range, the reactivity with the crosslinking agent can be increased, and this contributes to shortening of the curing time of the binder.

The aqueous binder may further contain at least one selected from the group consisting of a curing accelerator, a silane coupling agent, a dustproofing agent, an antirust agent, a neutralizing agent, and a colorant. By adding such a material, the performance of the aqueous binder can be optimized in accordance with the curing step and the raw materials used (inorganic fibers and the like), and therefore, the aqueous binder can be prepared into a formulation appropriate for the final use application.

The present invention also provides a heat-insulating and sound-absorbing inorganic fiber material comprising an inorganic fiber and a cured product of an aqueous binder fixing the inorganic fiber.

The present invention also provides a method for shortening the curing time of an aqueous binder for a heat-insulating and sound-absorbing inorganic fiber material, the aqueous binder comprising a polymer having a carboxy group and a crosslinking agent for this polymer, the method comprising incorporating an alkanol monoamine and a polyamine having an imino group as the crosslinking agent. To express the present method from another aspect, it can be said that the present method is a method for manufacturing an aqueous binder for a heat-insulating and sound-absorbing inorganic fiber material that comprises a polymer having a carboxy group and a crosslinking agent for this polymer and has a shortened curing time, the manufacturing method comprising a step of incorporating an alkanol monoamine and a polyamine having an imino group as the crosslinking agent.

### Advantageous Effects of Invention

According to the present invention, there are provided an aqueous binder for a heat-insulating and sound-absorbing inorganic fiber material, the aqueous binder having sufficient water dilution capacity even without containing ammonia, having a sufficiently rapid curing rate, and having excellent environmental safety, and a heat-insulating and sound-absorbing inorganic fiber material obtained by using the aqueous binder.

### DESCRIPTION OF EMBODIMENTS

Hereinafter, embodiments of the present invention will be described.

A polymer having a carboxy group means a macromolecule comprising at least one carboxy group in the molecule. Incidentally, as a concept to be contrasted with the “crosslinking agent”, this polymer may be referred to as “main agent”.

It is preferable that the polymer having a carboxy group is a polymer having an ethylenically unsaturated monomer having a carboxy group as a monomer unit, that is, a polymer obtained by polymerizing an ethylenically unsaturated monomer having a carboxy group. Incidentally, regarding the ethylenically unsaturated monomer having a carboxy group, one kind or two or more kinds thereof can be used. The monomer unit constituting the polymer having a carboxy group may be composed only of an ethylenically unsaturated monomer having a carboxy group or may be composed of an ethylenically unsaturated monomer having a carboxy group and a copolymerization monomer that does not have a carboxy group. In the case of the latter, the content of the ethylenically unsaturated monomer having a carboxy group is preferably 90% by mass or more, and more preferably 95% by mass or more, based on the total quantity of the monomers.

Examples of the ethylenically unsaturated monomer having a carboxy group comprise (meth)acrylic acid, crotonic acid, fumaric acid, maleic acid, 2-methylmaleic acid, itaconic acid, 2-methylitaconic acid, α-β-methyleneglutaric acid, a monoalkyl maleate, a monoalkyl fumarate, maleic anhydride, acrylic anhydride, β-(meth)acryloyloxyethylene hydrodiene phthalate, β-(meth)acryloyloxyethylene hydrodiene maleate, and β-(meth)acryloyloxyethylene hydrodiene succinate. Among these, from the viewpoint that it is easy to control the molecular weight of the polymer having a carboxy group, it is preferable to use (meth)acrylic acid, and acrylic acid is particularly preferred. Furthermore, in a case where the acid value of the polymer having a carboxy group is adjusted to a high value (for example, around 900 mg KOH/g), it is preferable to use maleic acid or fumaric acid. Incidentally, (meth)aciyl means acryl or methacryl, and the same also applies to similar compounds.

Examples of the copolymerization monomer that does not have a carboxy group comprise acrylic monomers such as methyl (meth)acrylate, ethyl (metb)acrylate, n-butyl (meth)acrylate, isobutyl (meth)acrylate, t-butyl (meth)acrylate, 2-ethylhexyl (meth)acrylate, cetyl (meth)acrylate, n-stearyl (meth)acrylate, diethylene glycol ethoxy(meth)acrylate, methyl-3-methoxy(meth)acrylate, ethyl-3-methoxy(meth)acrylate, butyl-3-methoxy(meth)acrylate, cyclohexyl (meth)acrylate, benzyl (meth)acrylate, isobornyl (meth)acrylate, tetrahydrofurfuryl acrylate, 2-hydroxyethyl acrylate, 2-hydroxypropyl acrylate, 4-hydroxybutyl acrylate, mono(meth)acrylate of a trivalent or higher-valent polyol, an aminoalkyl (meth)aciylate, an N-alkylaminoalkyl (meth)acrylate, and an N,N-dialkylaminoalkyl (meth)acrylate; vinyl-based monomers such as a vinyl alkyl ether, an N-alkylvinylamine, an N,N-dialkylvinylamine, N-vinylpyridine, N-vinylimidazole, and an N-(alkyl)aminoalkylvinylamine; amide-based monomers such as (meth)aciylamide, an N-alkyl (meth)acrylamide, an N,N-dialkyl (meth)acrylamide, an N,N-dialkylaminoalkyl (meth)acrylamide, diacetone (meth)acrylamide, N-vinylformamide, N-vinylacetamide, and N-vinylpyrrolidone; aliphatic unsaturated hydrocarbons such as ethylene, propylene, isobutylene, isoprene, and butadiene; styrene-based monomers such as styrene, α-methylstyrene, p-methoxystyrene, vinyltoluene, p-hydroxystyrene, and p-acetoxystyrene; vinyl ester-based monomers such as vinyl acetate and vinyl propionate; acrylonitrile, and glycidyl (meth)acrylate. These can be used singly or in combination of two or more kinds thereof.

The weight average molecular weight of the polymer having a carboxy group is preferably 1000 to 20000, more preferably 2000 to 15000, and even more preferably 2000 to 10000. When the weight average molecular weight of the polymer having a carboxy group is within these numerical value ranges, the fluidity of the aqueous binder is likely to be suitable for application to the inorganic fibers, and the variation in the amount of attachment of the aqueous binder can be suppressed. Furthermore, with regard to the manufacturing of the heat-insulating and sound-absorbing inorganic fiber material, application of the aqueous binder to fibers is often carried out in a high temperature atmosphere at about 200° C. to 350° C. immediately after being fiberized by a centrifugation method or the like, and at that time, volatilization of water in the aqueous binder can be satisfactorily achieved. Incidentally, the weight average molecular weight is a value measured by gel permeation chromatography (GPC) and calculated relative to polystyrene standards.

The acid value of the polymer having a carboxy group is preferably 500 to 900 mg KOH/g, and more preferably 550 to 750 mg KOH/g. When the acid value of the polymer having a carboxy group is within these numerical value ranges, the strength and rigidity of an aqueous binder cured product are increased, and the thickness restorability after opening of a press-packed bale of the obtained heat-insulating and sound-absorbing inorganic fiber material and the rigidity of the heat-insulating and sound-absorbing inorganic fiber material processed into a board form are enhanced. Furthermore, heat insulation properties, sound absorption properties, or workability during construction such as self-standing properties are excellent. Incidentally, the acid value means the number of milligrams of potassium hydroxide (mg KOH) required for neutralizing 1 g of the polymer having a carboxy group.

The weight average molecular weight of the polymer having a carboxy group is correlated not only with the fluidity of the aqueous binder but also with the curing rate and the crosslinking density after curing, and even for polymers having a carboxy group having the same acid value, when the molecular weights thereof are different, the curing rate of the aqueous binder and the strength of the aqueous binder cured product fluctuate, so that the physical properties of the obtained heat-insulating and sound-absorbing inorganic fiber material also change. For example, as the weight average molecular weight of the polymer having a carboxy group is smaller, the curing rate of the aqueous binder is faster; however, the cured product tends to be brittle, so that depending on the production conditions of the manufacturing line, desired physical properties may not be obtained. When the weight average molecular weight of the polymer having a carboxy group is in the above-described range, optimization of the fluidity of the aqueous binder and the various physical properties of the obtained heat-insulating and sound-absorbing inorganic fiber material can be promoted.

The blending amount (in terms of solid content) of the polymer having a carboxy group in the aqueous binder is preferably 60% to 90% by mass, and more preferably 65% to 88% by mass, based on the total mass of the aqueous binder in terms of solid content.

Regarding the alkanol monoamine, the number of carbon atoms of the alkanol group is preferably 1 to 6, and more preferably 1 to 3.

Examples of such an alkanol monoamine comprise monoethanolamine, diethanolamine, triethanolamine, monoisopropanolamine, diisopropanolamine, triisopropanolamine, N-methylethanolamine, and N-methyldiethanolamine.

Examples of the polyamine having an imino group comprise an aliphatic polyamine, an alicyclic polyamine, and an aromatic polyamine. Among them, from the viewpoint of water-solubility, an aliphatic polyamine is preferred, and an aliphatic polyamine (preferably, linear) having a polyalkylene polyamine skeleton may be used.

Examples of the polyamine having an imino group comprise diethylenetriamine, triethylenetetramine, tetraethylenepentamine, pentaethylenehexamine, hexaethyleneheptamine, heptaethyleneoctamine, N-(3-aminopropyl)butane-1,4-diamine, N,N-di(3-aminopropyl)butane-1,4-diamine, and bishexamethylenetriamine.

The molecular weight of the polyamine having an imino group is preferably 100 to 500, more preferably 130 to 400, and even more preferably 130 to 250. In the case of the polyamine as well, similarly to the polymer having a carboxy group, the molecular weight affects the fluidity of the aqueous binder and the curing behavior of the aqueous binder. When the weight average molecular weight of the polyamine is within the above-described range, optimization of the fluidity of the aqueous binder and the various physical properties of the obtained heat-insulating and sound-absorbing inorganic fiber material can be promoted.

The amine value of the polyamine having an imino group is preferably 1150 to 1650 mg KOH/g or 1200 to 1650 mg KOH/g, more preferably 1200 to 1600 mg KOH/g, even more preferably 1200 to 1550 mg KOH/g, and particularly preferably 1400 to 1550 mg KOH/g. By adjusting the amine value to be in the above-described numerical value ranges, the polyamine rapidly reacts with the polymer having a carboxy group, the rate of increase in the molecular weight of the aqueous binder cured product increases, and the strength of the aqueous binder cured product is increased.

The blending amount (in terms of solid content) of the polyamine having an imino group in the aqueous binder is preferably 0.01% to 5.0% by mass, and more preferably 0.03% to 4.0% by mass, based on the total mass of the aqueous binder in terms of solid content.

Regarding the crosslinking agent, incorporation of a component other than the alkanol monoamine and the polyamine having an imino group, which are essential components, is not excluded; however, the total content occupied by the alkanol monoamine and the polyamine having an imino group in the total amount of the crosslinking agent is preferably 90% by mass or more, more preferably 95% by mass or more, and may be 100% by mass. Incidentally, examples of the polyamine other than the polyamine having an imino group comprise 1,2,3-propanetriamine and 1,1,4,4-butanetetraamine.

The ratio of the total number of moles of hydroxyl groups, amino groups, and imino groups in the crosslinking agent with respect to the number of moles of carboxy groups in the polymer having a carboxy group is preferably 0.5 or higher. This ratio is more preferably 0.6 to 1.2, and even more preferably 0.7 to 1.1. By adjusting the mole ratio to be within these numerical value ranges, the polymer having a carboxy group and the crosslinking agent component are likely to form a crosslinked structure without excess or deficiency, the strength of the aqueous binder cured product becomes strong, and the various physical properties of the obtained heat-insulating and sound-absorbing inorganic fiber material can be optimized. Incidentally, when the ratio is more than 1.2, the strength of a cured product of the aqueous binder may be lowered.

The ratio of the total number of moles of amino groups and imino groups in the crosslinking agent with respect to the total number of moles of hydroxyl groups, amino groups, and imino groups in the crosslinking agent is preferably 0.6 or less. This ratio is more preferably 0.01 to 0.6 and may be 0.01 to 0.5 or 0.01 to 0.4. When the mole ratio is adjusted to be within these numerical value ranges, the polymer having a carboxy group as well as the alkanol monoamine and the polyamine having an imino group, which are crosslinking agent components, rapidly form a crosslinked structure, the mechanical strength of the obtained heat-insulating and sound-absorbing inorganic fiber material is excellent, and the dimensional securement as a heat-insulating material is further facilitated.

The aqueous binder may contain a curing accelerator such as a reducing inorganic salt. Examples of the curing accelerator comprise a hypophosphite and a sulfite, and these can be used singly or in combination of two or more kinds thereof. Examples of the hypophosphite comprise sodium hypophosphite, lithium hypophosphite, potassium hypophosphite, calcium hypophosphite, magnesium hypophosphite, and strontium hypophosphite. Examples of the sulfite comprise lithium hydrogen sulfite, sodium hydrogen sulfite, potassium hydrogen sulfite, magnesium hydrogen sulfite, calcium hydrogen sulfite, calcium hydrogen sulfite, and ammonium hydrogen sulfite, and among them, lithium hydrogen sulfite, sodium hydrogen sulfite, or ammonium hydrogen sulfite, all of which have large contents of sulfite ions having a curing accelerating action, is preferred.

The blending amount of the curing accelerator is preferably 0.1 to 10 parts by mass, and more preferably 0.5 to 5 parts by mass, in terms of solid content, with respect to 100 parts by mass of the sum of the polymer having a carboxy group and the crosslinking agent.

The aqueous binder may contain a silane coupling agent. The silane coupling agent acts at the interface between the inorganic fibers and the aqueous binder cured product and can enhance the adhesion of the aqueous binder cured product to the inorganic fibers. Examples of the silane coupling agent comprise aminosilane coupling agents such as γ-aminopropyltriethoxysilane, γ-(2-aminoethyl)aminopropyltrimethoxysilane, and γ-(2-aminoethyl)aminopropylmethyldimethoxysilane; and epoxysilane coupling agents such as γ-glycidoxypropyltrimethoxysilane and γ-glycidoxypropylmethyldimethoxysilane, and these can be used singly or in combination of two or more kinds thereof.

The blending amount of the silane coupling agent is preferably 0.1 to 2.0 parts by mass in terms of solid content with respect to 100 parts by mass of the sum of the polymer having a carboxy group and the crosslinking agent.

The aqueous binder may contain an antirust agent. An antirust agent can suppress corrosion of the production facilities. Examples of the antirust agent comprise thiourea-based compounds such as thiourea, thiosemicarbazide, N-phenylthiourea, o-tolylthiourea, N-methylthiourea, 1,3-dimethylthiourea, N,N′-diethylthiourea, 1,3-dibutylthiourea, tetramethylthiourea, 1,3-diphenyl-2-thiourea, 1,3-diisopropylthiourea, ethylenethiourea, 2-mercaptobenzothiazole, and trimethylthiourea, and these can be used singly or in combination of two or more kinds thereof. Incidentally, an alkanol monoamine may also function as an antirust agent; however, when the aqueous binder comprises an alkanol monoamine, the alkanol monoamine is not comprised in the antirust agent and is dealt with as a crosslinking agent.

The blending amount of the antirust agent is preferably 0.0001 to 1.0 parts by mass in terms of solid content with respect to 100 parts by mass of the sum of the polymer having a carboxy group and the crosslinking agent.

In the aqueous binder, a heavy oil water dispersion as a dustproofing agent, a colorant, an inorganic sulfate (neutralizing agent) for neutralizing alkaline components eluted from inorganic fibers of glass and the like, other additives, and the like can be further incorporated as necessary. Examples of the inorganic sulfate comprise ammonium sulfate.

The pH of the aqueous binder is preferably 3.5 to 8.0, more preferably 4.0 to 7.0, and even more preferably 4.0 to 6.5. When the pH is adjusted to be within these numerical value ranges, stability is enhanced, a waste water treatment is made easier, and therefore, reduction of the maintenance cost can be promoted. The pH can be adjusted by adding a pH adjusting agent; however, when the aqueous binder of the present invention is used, the pH usually falls in the above-described range even without the addition of a pH adjusting agent.

The aqueous binder can be manufactured by, for example, introducing a polymer having a carboxy group and a crosslinking agent as well as a curing accelerator, a silane coupling agent, an antirust agent, a dustproofing agent, a colorant, a neutralizing agent, and other additives as necessary into a tank equipped with a stirrer such as a dissolver, and mixing the components.

Examples of the form of the aqueous binder comprise an emulsion, a colloidal dispersion, and a water-soluble solution, and any of these forms may be adopted. Here, an emulsion means a product that is emulsified with an emulsifier other than the resin component (a polymer having a carboxy group, or the like) in the aqueous binder, for example, a surfactant or the like, and a colloidal dispersion means a product in which a resin component is dispersed in water by means of a functional group in the resin component, while generally, both of them exhibit a milky white external appearance. Meanwhile, a water-soluble composition means a product in which a resin component is dissolved in water, and the external appearance is also transparent or close to transparency.

Regarding the form of the aqueous binder, as will be described below, from the viewpoint that process control is easy, a water-soluble composition is more advantageous than an emulsion or a colloidal dispersion. That is, in an emulsion and a colloidal dispersion, the resin component (polymer having a carboxy group, or the like) dispersed therein has characteristics with low solubility and swellability in water, and when water as the medium is evaporated, a film is easily formed. When the resin component in the aqueous binder forms a film before curing, the fluidity of the aqueous binder at the inorganic fiber surface is susceptible to damage, a heat-insulating and sound-absorbing inorganic fiber material in which the amount of attachment of the aqueous binder is homogeneous cannot be obtained, and also, there are many portions that are lacking in the binding between inorganic fibers by the aqueous binder, so that it may be difficult to maintain the shape as a manufactured product. Furthermore, in a colloidal dispersion and an emulsion, once water as the medium is evaporated and a film is formed, the colloidal dispersion and the emulsion are not likely to return to aqueous materials again, and therefore, when the aqueous binder adheres to a manufacturing facility or the like, washing becomes complicated so that a decrease in productivity is likely to occur.

On the other hand, when the aqueous binder is a water-soluble composition, even when water is slowly evaporated from the aqueous binder, film formation does not immediately occur, and therefore, there is no problem such as described above. Accordingly, it is preferable that the aqueous binder is prepared as a water-soluble composition.

Despite the circumstances such as described above, since the emulsion or colloidal dispersion can be used practically without any problem by using the emulsion or colloidal dispersion under humidifying conditions or by adjusting the water content, which form among an emulsion, a colloidal dispersion, and a water-soluble composition should be adopted may be appropriately determined according to the use environment of the aqueous binder.

Furthermore, the solid content of the aqueous binder is preferably 5% to 50% by mass, and more preferably 10% to 40% by mass. When the solid content is adjusted to 5% by mass or more, since the amount of water is an appropriate amount, the curing step does not take excessive time, and satisfactory productivity can be maintained. When the solid content is adjusted to 50% by mass or less, a decrease in the fluidity of the aqueous binder can be prevented. Here, the solid content means a component that is not volatilized when the aqueous binder is heated to a temperature of room temperature (about 23° C.) or higher and 100° C. or lower at 1 atmosphere. Meanwhile, it is preferable that the component other than the solid content (volatile component) is water.

The heat-insulating and sound-absorbing inorganic fiber material according to the embodiments comprises inorganic fibers and a cured product of the above-described aqueous binder that fixes the inorganic fibers. That is, the heat-insulating and sound-absorbing inorganic fiber material can be obtained by applying the above-described aqueous binder to inorganic fibers, heating the aqueous binder to cure, and then performing molding.

The density of the heat-insulating and sound-absorbing inorganic fiber material may be any density that is used for conventional heat-insulating materials and sound-absorbing materials, and the density is preferably 5 to 300 kg/m³.

The heat-insulating and sound-absorbing inorganic fiber material can be manufactured, for example, as follows. That is, first, molten inorganic raw materials are fiberized with a fiberization apparatus, and immediately thereafter, an aqueous binder is applied to the inorganic fibers. Next, the inorganic fibers to which the aqueous binder has been applied are deposited on a perforated conveyor to form an intermediate for a bulky heat-insulating and sound-absorbing inorganic fiber material, the intermediate is sent off between a pair of upper and lower perforated conveyors or the like with a spacing provided so as to have a desired thickness so as to be heated while being compressed therebetween, and the aqueous binder is cured to form a heat-insulating and sound-absorbing inorganic fiber material. The heat-insulating and sound-absorbing inorganic fiber material is coated with a skin material or the like as necessary and then is cut into desired widths and lengths.

Regarding the inorganic fibers, glass wool, rock wool, and the like that are used in conventional heat-insulating and sound-absorbing materials can be used. Regarding a method for fiberizing inorganic fibers, for example, various methods such as a blaze method, a blow-off method, and a centrifugation method (also called rotary method) can be used. When the inorganic fibers are glass wool, it is preferable to use a centrifugation method.

The timing for applying the aqueous binder to the inorganic fibers may be next to fiberization, and from the viewpoint of efficiently applying the aqueous binder, it is preferable to apply the aqueous binder immediately after fiberization.

Regarding the method of applying the aqueous binder to the inorganic fibers, a method of coating or spraying the aqueous binder by using a spraying apparatus or the like may be mentioned. The adjustment of the amount of application of the aqueous binder can be carried out by a method similar to the case of a conventional binder that does not comprise a water-repellent. The amount of application of the aqueous binder may vary depending on the density or the use application of the heat-insulating and sound-absorbing inorganic fiber material; however, the amount of application is preferably 0.5% to 30% by mass, and more preferably 0.5% to 20% by mass, in terms of solid content, based on the mass of the heat-insulating and sound-absorbing inorganic fiber material to which the aqueous binder has been applied.

The inorganic fibers to which the aqueous binder has been applied by the above-described step are deposited on a perforated conveyor and forms a bulky inorganic fiber intermediate. Here, when the inorganic fibers are deposited on a perforated conveyor, it is preferable to perform suctioning by a suctioning apparatus from the opposite side of the perforated conveyor where the inorganic fibers are deposited.

Regarding the method of heating the aqueous binder, for example, heating by a hot air oven may be mentioned. The heating temperature inside the hot air oven can be adjusted to, for example, 200° C. to 350° C. The heating and curing time can be appropriately adjusted to be between 30 seconds and 10 minutes, depending on the density and thickness of the heat-insulating and sound-absorbing inorganic fiber material.

The heat-insulating and sound-absorbing inorganic fiber material may be used in the form as it is or may be used after being coated with a skin material. Regarding the skin material, for example, paper, a synthetic resin film, a metal foil film, a nonwoven fabric, a woven fabric, or a combination of these can be used.

Other aspects of the present embodiment comprise the following.

An aqueous binder for a heat-insulating and sound-absorbing inorganic fiber material, the aqueous binder comprising a polymer having a carboxy group and a crosslinking agent for the polymer,
wherein the crosslinking agent comprises an alkanol monoamine and a polyamine having an imino group,
the polyamine has an amine value of 1200 to 1650 mg KOH/g, and
a ratio of the total number of mole of an amino group and an imino group in the crosslinking agent with respect to the total number of mole of a hydroxyl group, an amino group, and an imino group in the crosslinking agent is 0.6 or less.

The aqueous binder according to [1], wherein the polymer has an ethylenically unsaturated monomer having a carboxy group as a monomer unit.

The aqueous binder according to [1] or [2], wherein a ratio of the total number of mole of a hydroxyl group, an amino group, and an imino group in the crosslinking agent with respect to the total number of mole of a carboxy group in the polymer is 0.5 or more.

The aqueous binder according to any one of [1] to [3], wherein the polyamine has a molecular weight of 100 to 500.

The aqueous binder according to any one of [1] to [4], wherein the polymer has a weight average molecular weight of 1000 to 20000.

The aqueous binder according to any one of [1] to [5], wherein the polymer has an acid value of 500 to 900 mg KOH/g.

The aqueous binder according to any one of [1] to [6], further containing at least one selected from the group consisting of a curing accelerator, a silane coupling agent, a dustproofing agent, an antirust agent, a neutralizing agent, and a colorant.

A heat-insulating and sound-absorbing inorganic fiber material comprising an inorganic fiber and a cured product of the aqueous binder according to any one of [1] to [7] for fixing the inorganic fiber.

A method for shortening a curing time of an aqueous binder for a heat-insulating and sound-absorbing inorganic fiber material, the aqueous binder comprising a polymer having a carboxy group and a crosslinking agent for the polymer,
wherein an alkanol monoamine and a polyamine having an imino group are incorporated as a crosslinking agent,
the polyamine has an amine value of 1200 to 1650 mg KOH/g, and
a ratio of the total number of mole of an amino group and an imino group in the crosslinking agent with respect to the total number of mole of a hydroxyl group, an amino group, and an imino group in the crosslinking agent is 0.6 or less.

A method for manufacturing an aqueous binder for a heat-insulating and sound-absorbing inorganic fiber material with a shortened curing time, the aqueous binder comprising a polymer having a carboxy group and a crosslinking agent for the polymer,
the method comprising a step of incorporating an alkanol monoamine and a polyamine having an imino group as the crosslinking agent,
wherein the polyamine has an amine value of 1200 to 1650 mg KOH/g, and
a ratio of the total number of mole of an amino group and an imino group in the crosslinking agent with respect to the total number of mole of a hydroxyl group, an amino group, and an imino group in the crosslinking agent is 0.6 or less.

With regard to the aqueous binder, a decrease in the binder pH is suppressed even without incorporating ammonia, for the reason that the aqueous binder comprises a polyamine having an imino group, whose amine value is in the range of 1200 to 1650 mg KOH/g, as the crosslinking agent. Therefore, the aqueous binder has sufficient water dilution capacity and a short curing time. In addition, since it is not necessary to add ammonia in order to suppress a decrease in pH, volatilization of ammonia does not occur at the time of use, and the aqueous binder also has excellent environmental safety. Incidentally, when the crosslinking agent has both a hydroxyl group and an amino group (or an imino group), in order to increase the curing rate, it is usually presumed that the quantity of hydroxyl groups is reduced while the quantity of amino groups (or imino groups) is increased. However, contrary to such understanding, with regard to the aqueous binder, despite that the mole ratio 2 is set to the low range side such as 0.6 or less, the curing rate, the water dilution capacity, and the storage stability are enhanced.

### EXAMPLES

Hereinafter, the invention will be specifically described based on Examples; however, the present invention is not intended to be limited to the following Examples. Hereinafter, an alkanol monoamine is referred to as “crosslinking agent 1”, and a polyamine having an imino group is referred to as “crosslinking agent 2”.

### Example 1

A polyacrylic acid (weight average molecular weight 10000, acid value 716 mg KOH/g), which was a main agent, obtained by radical polymerization by using sodium hypophosphite as a chain transfer agent was dissolved in water to obtain a resin solution (solid content 46%). 74.3 parts by mass in terms of solid content of the resin solution, 0.3 parts by mass in terms of solid content of triethylenetetramine (molecular weight 146, amine value 1535 mg KOH/g, crosslinking agent 2), 25.4 parts by mass in terms of solid content of diethanolamine (crosslinking agent 1), and 2.0 parts by mass of sodium hypophosphite as a curing accelerator were mixed to obtain a water-soluble composition. Furthermore, 0.6 parts by mass of γ-aminopropyltriethoxysilane was added thereto, the mixture was stirred, subsequently the mixture was diluted with water such that the solid content was 15%, and 5.0 parts by mass of a heavy oil aqueous dispersion having a solid content of 40% and 8.0 parts by mass of ammonium sulfate were added thereto to obtain an aqueous binder. The ratio of the total number of moles of hydroxyl groups, amino groups, and imino groups in the crosslinking agent with respect to the total number of moles of carboxy groups in the polymer having a carboxy group was 0.8, and the ratio of the total number of moles of amino groups and imino groups in the crosslinking agent with respect to the total number of moles of hydroxyl groups, amino groups, and imino groups in the crosslinking agent was 0.34.

### Example 2

n aqueous binder was obtained in the same manner as in Example 1, except that 71.9 parts by mass in terms of solid content of the resin solution as a main agent, 1.5 parts by mass in terms of solid content of pentaethylenehexamine (molecular weight 232, amine value 1449 mg KOH/g) as the crosslinking agent 2, and 26.6 parts by mass in terms of solid content of diethanolamine as the crosslinking agent 1 were used. The mole ratio 1 was 0.9, and the mole ratio 2 was 0.36.

### Example 3

An aqueous binder was obtained in the same manner as in Example 1, except that 67.1 parts by mass in terms of solid content of the resin solution as a main agent, 0.3 parts by mass in terms of solid content of triethylenetetramine (molecular weight 146, amine value 1535 mg KOH/g) as the crosslinking agent 2, and 32.6 parts by mass in terms of solid content of triethanolamine as the crosslinking agent 1 were used. The mole ratio 1 was 0.8, and the mole ratio 2 was 0.01.

### Example 4

An aqueous binder was obtained in the same manner as in Example 1, except that 62.1 parts by mass in terms of solid content of the resin solution as a main agent, 0.9 parts by mass in terms of solid content of pentaethylenehexamine (molecular weight 232, amine value 1449 mg KOH/g) as the crosslinking agent 2, and 37.0 parts by mass in terms of solid content of triethanolamine as the crosslinking agent 1 were used. The mole ratio 1 was 1, and the mole ratio 2 was 0.03.

### Example 5

An aqueous binder was obtained in the same manner as in Example 1, except that 0.6 parts by mass of γ-glycidoxypropyltrimethoxysilane as a silane coupling agent was added. The mole ratio 1 was 1, and the mole ratio 2 was 0.03.

### Example 6

An aqueous binder was obtained in the same manner as in Example 1, except that 0.01 parts by mass of N,N′-diethylthiourea (ACCEL EUR manufactured by Kawaguchi Chemical Industry Co., LTD., containing 99% or more of N,N′-diethylthiourea) as an antirust agent was added. The mole ratio 1 was 1, and the mole ratio 2 was 0.03.

### Example 7

An aqueous binder was obtained in the same manner as in Example 1, except that 72.7 parts by mass in terms of solid content of the resin solution as a main agent, 0.3 parts by mass in terms of solid content of poly-8 (a polyamine having heptaethyleneoctamine as a main component, molecular weight 318, amine value 1200 mg KOH/g, manufactured by Tosoh Corporation) as the crosslinking agent 2, and 27.0 parts by mass in terms of solid content of triethanolamine as the crosslinking agent 1 were used. The mole ratio 1 was 0.6, and the mole ratio 2 was 0.01.

### Comparative Example 1

A polyacrylic acid (weight average molecular weight 10000, acid value 716 mg KOH/g), which was a main agent, obtained by radical polymerization by using sodium hypophosphite as a chain transfer agent was dissolved in water to obtain a resin solution (solid content 46%). 72.5 parts by mass in terms of solid content of the resin solution, 0.3 parts by mass in terms of solid content of triethylenetetramine (molecular weight 146, amine value 1535 mg KOH/g, crosslinking agent 2), 27.2 parts by mass in terms of solid content of glycerol, and 2.0 parts by mass of sodium hypophosphite as a curing accelerator were mixed, and a water-soluble composition adjusted to pH 6.5 with 25% aqueous ammonia was obtained. Furthermore, 0.6 parts by mass of γ-aminopropyltriethoxysilane was added thereto, the mixture was stirred and then diluted with water such that the solid content was 15%, and 5.0 parts by mass of a heavy oil aqueous dispersion having a solid content of 40% and 8.0 parts by mass of ammonium sulfate were added thereto to obtain an aqueous binder. The mole ratio 1 was 1, and the mole ratio 2 was 0.01.

### Comparative Example 2

An aqueous binder was obtained in the same manner as in Comparative Example 1, except that 68.9 parts by mass in terms of solid content of the resin solution as a main agent, 0.8 parts by mass in terms of solid content of pentaethylenehexamine (molecular weight 232, amine value 1449 mg KOH/g) as the crosslinking agent 2, and 30.3 parts by mass in terms of solid content of sorbitol were used. The mole ratio 1 was 1.2, and the mole ratio 2 was 0.02.

### Comparative Example 3

An aqueous binder was obtained in the same manner as in Comparative Example 1, except that 80.7 parts by mass in terms of solid content of the resin solution as a main agent and 19.3 parts by mass in terms of solid content of pentaethylenehexamine (molecular weight 232, amine value 1449 mg KOH/g) as the crosslinking agent 2 were used, and the crosslinking agent 1 was not added. The mole ratio 1 was 0.5, and the mole ratio 2 was 1.00.

### Comparative Example 4

An aqueous binder was obtained in the same manner as in Comparative Example 1, except that 60.7 parts by mass in terms of solid content of the resin solution as a main agent and 39.3 parts by mass in terms of solid content of diethanolamine as the crosslinking agent 1 were used, and the crosslinking agent 2 was not added. The mole ratio 1 was 1.5, and the mole ratio 2 was 0.33.

With regard to the aqueous binders obtained in Examples 1 to 7 and Comparative Examples 1 to 4, the shell mold breaking strength, the curing time, and the pH were investigated. The evaluation methods will be described below. Furthermore, the evaluation results are shown in Tables 1 to 3. Incidentally, with regard to the aqueous binders of Examples 1 to 7, volatilization of ammonia does not occur at the time of use, and the aqueous binders have excellent environmental safety. On the other hand, with regard to the aqueous binders of Comparative Examples 1 to 4, there is concern about environmental safety because volatilization of ammonia occurs.

### Shell Mold Breaking Strength

Glass beads were impregnated with a binder formulation such that the solid content was 2.7%, the glass beads were shaped with a dog-bone mold, the samples were calcined at 210° C. × 30 minutes, and then a tensile test was performed for each of the aqueous binders with n = 6. In the present test, the breaking strength was measured with the following apparatus under the following test conditions.

Apparatus: Tabletop Material Testing Instruments STB-1225S (manufactured by A&D Company, Limited)

Conditions: Load cell 2.5 kN, tensile speed 5 mm/min.

From the results of the tensile test shown in Tables 1 to 3, it was found that the aqueous binder had sufficient strength after being cured.

### Curing Time

The curing behavior of the binder formulation (solid content concentration 35%) was measured with a dynamic viscoelasticity measuring apparatus (conditions: 30° C. to 160° C. (4° C./min.), 160° C. hold, phi = 1 °, f = 1 Hz, gap 1 mm, plate 20 mm).

### Binder pH

The pH of the binder formulation was measured with a pH meter.

Table 1

| | Raw material | Example 1 | Example 2 | Example 3 | Example 4 |
|---|---|---|---|---|---|
| Main agent | Polyacrylic acid | 74.3 | 71.9 | 67.1 | 62.1 |
| Crosslinking agent 1 | Diethanolamine | 25.4 | 26.6 | | |
| | Triethanolamine | | | 32.6 | 37.0 |
| | Glycerol | | | | |
| | Sorbitol | | | | |
| Crosslinking agent 2 | Triethylenetetramine | 0.3 | | 0.3 | |
| | Pentaethylenehexamine | | 1.5 | | 0.9 |
| Silane coupling agent | γ-Aminopropyltriethoxysilane | 0.6 | 0.6 | 0.6 | 0.6 |
| | γ-Glycidoxypropyltrimethoxysilane | | | | |
| Antirust agent | ACCEL EUR | | | | |
| | Mole ratio 1 | 0.8 | 0.9 | 0.8 | 1 |
| | Mole ratio 2 | 0.34 | 0.36 | 0.01 | 0.03 |
| Evaluation results | Shell mold breaking strength | 131 | 127 | 111 | 107 |
| | Curing time (min) | 51 | 50 | 54 | 52 |
| | Binder pH | 4.2 | 4.4 | 4.2 | 4.5 |

Table 2

| | Raw material | Example 5 | Example 6 | Example 7 |
|---|---|---|---|---|
| Main agent | Polyacrylic acid | 74.3 | 74.3 | 72.7 |
| Crosslinking agent 1 | Diethanolamine | 25.4 | 25.4 | |
| | Triethanolamine | | | 27.0 |
| | Glycerol | | | |
| | Sorbitol | | | |
| Crosslinking agent 2 | Triethylenetetramine | 0.3 | 0.3 | |
| | Pentaethylenehexamine | | | |
| | poly-8 | | | 0.3 |
| Silane coupling agent | γ-Aminopropyltriethoxysilane | | 0.6 | 0.6 |
| | γ-Glycidoxypropyltrimethoxysilane | 0.6 | | |
| Antirust agent | ACCEL EUR | | 0.01 | |
| | Mole ratio 1 | 0.8 | 0.8 | 0.6 |
| | Mole ratio 2 | 0.34 | 0.34 | 0.01 |
| Evaluation results | Shell mold breaking strength | 132 | 130 | 115 |
| | Curing time (min) | 50 | 52 | 54 |
| | Binder pH | 4.2 | 4.2 | 4.2 |

Table 3

| | Raw material | Comparative Example 1 | Comparative Example 2 | Comparative Example 3 | Comparative Example 4 |
|---|---|---|---|---|---|
| Main agent | Polyacrylic acid | 72.5 | 68.9 | 80.7 | 60.7 |
| Crosslinking agent 1 | Diethanolamine | | | | 39.3 |
| | Triethanolamine | | | | |
| | Glycerol | 27.2 | | | |
| | Sorbitol | | 30.3 | | |
| crosslinking agent 2 | Triethylenetetramine | 0.3 | | | |
| | Pentaethylenehexamine | | 0.8 | 19.3 | |
| | Mole ratio 1 | 1 | 1.2 | 0.5 | 1.5 |
| | Mole ratio 2 | 0.01 | 0.02 | 1.00 | 0.33 |
| Evaluation results | Shell mold breaking strength | 100 | 112 | 93 | 96 |
| | Curing time (minutes) | 213 | 211 | 58 | 63 |
| | Binder pH | 6.7 | 6.5 | 6.4 | 6.6 |

1. An aqueous binder for a heat-insulating and sound-absorbing inorganic fiber material, the aqueous binder comprising a polymer having a carboxy group and a crosslinking agent for the polymer,
wherein the crosslinking agent comprises an alkanol monoamine and a polyamine having an imino group,
the polyamine has an amine value of 1200 to 1650 mg KOH/g, and
a ratio of the total number of mole of an amino group and an imino group in the crosslinking agent with respect to the total number of mole of a hydroxyl group, an amino group, and an imino group in the crosslinking agent is 0.6 or less.

2. The aqueous binder according to claim 1, wherein the polymer has an ethylenically unsaturated monomer having a carboxy group as a monomer unit.

3. The aqueous binder according to claim 1 wherein a ratio of the total number of mole of a hydroxyl group, an amino group, and an imino group in the crosslinking agent with respect to the total number of mole of a carboxy group in the polymer is 0.5 or more.

4. The aqueous binder according to claim 1 wherein the polyamine has a molecular weight of 100 to 500.

5. The aqueous binder according to claim 1 wherein the polymer has a weight average molecular weight of 1000 to 20000 and an acid value of 500 to 900 mg KOH/g.

6. The aqueous binder according to claim 1 further comprising at least one selected from the group consisting of a curing accelerator, a silane coupling agent, a dustproofing agent, an antirust agent, a neutralizing agent, and a colorant.

7. A heat-insulating and sound-absorbing inorganic fiber material comprising an inorganic fiber and a cured product of the aqueous binder according to claim 1 for fixing the inorganic fiber.

8. A method for shortening a curing time of an aqueous binder for a heat-insulating and sound-absorbing inorganic fiber material, the aqueous binder comprising a polymer having a carboxy group and a crosslinking agent for the polymer,
wherein an alkanol monoamine and a polyamine having an imino group are incorporated as the crosslinking agent,
the polyamine has an amine value of 1200 to 1650 mg KOH/g,
a ratio of the total number of mole of an amino group and an imino group in the crosslinking agent with respect to the total number of mole of a hydroxyl group, an amino group, and an imino group in the crosslinking agent is 0.6 or less.

9. A method for manufacturing an aqueous binder for a heat-insulating and sound-absorbing inorganic fiber material with a shortened curing time, the aqueous binder comprising a polymer having a carboxy group and a crosslinking agent for the polymer,
the method comprising a step of incorporating an alkanol monoamine and a polyamine having an imino group as the crosslinking agent,
wherein the polyamine has an amine value of 1200 to 1650 mg KOH/g, and
a ratio of the total number of mole of an amino group and an imino group in the crosslinking agent with respect to the total number of mole of a hydroxyl group, an amino group, and an imino group in the crosslinking agent is 0.6 or less.
